(19) United States
(12) Patent Application Publication
(10) Pub. No.: US 2012/0314681 A1
(43) Pub. Date: Dec. 13, 2012

(54) METHODS AND APPARATUS FOR MEDIA ACCESS CONTROL IN TV WHITE SPACE

(75) Inventors: Hou-Shin Chen, Cincinnati, OH (US); Wen Gao, West Windsor, NJ (US)

(73) Assignee: THOMSON LICENSING, Issy Les Moulineaux (FR)

(21) Appl. No.: 13/581,626

(22) PCT Filed: Mar. 15, 2011
(86) PCT No.: PCT/US11/00476

§ 371 Date: Aug. 29, 2012

Related U.S. Application Data
(60) Provisional application No. 61/313,901, filed on Mar. 15, 2010.

(51) Int. Cl. H04W 74/00

(52) U.S. Cl. 370/329

(57) ABSTRACT

Methods and apparatus for using 802.11 Wireless LANs in TV white space that allow networks with overlapping wireless regions to coexist. The methods and apparatus offer a solution to the mutated hidden node problem. Wireless devices communicate with a coexistence manager over a backhaul connection. Signals are sent by a low power station indicating a request to use a portion of spectrum. The coexistence manager communicates with a plurality of second stations that transmit at a higher power level. The plurality of second stations either send a signal to the first station indicating that it can transmit, or send signals so that the first station can determine which interference it is receiving, after which the coexistence manager tells the interfering station to transmit a signal to the first station indicating when it can transmit.

### CROSS-REFERENCE TO RELATED APPLICATIONS

This application claims the benefit of U.S. Provisional Application Ser. No. 61/313901 , entitled “MAC AND PHY PROPOSAL FOR 802.11AF,” filed Mar. 15, 2010, which is incorporated by reference herein in its entirety.

### FIELD OF THE INVENTION

The present principles relate to methods and apparatus for media access control of 802.11 of devices in TV white space that uses unoccupied television spectrum.

### BACKGROUND OF THE INVENTION

Recently, the Federal Communications Commission (FCC) has approved the operation of unlicensed radio transmitters in the broadcast television spectrum at locations where that spectrum is not being used by licensed services, such as television stations and wireless microphone operators, under certain rules. This unused TV spectrum is often termed “white spaces”. A concept called Cognitive Radio was proposed to implement negotiated, or opportunistic, spectrum sharing to improve spectrum efficiency for these frequencies.

It can be expected that the implementation of Cognitive Radio (CR) in TV white space will be a major topic within wireless communication into the future and provide a viable solution to the problem of scarcity of the wireless spectrum. In 2004, based on the expectation of unlicensed use of TV white space, under the charter of an IEEE 802 Standards Committee, a working group named IEEE 802.22 was established to develop a standard for a Cognitive Radio-based PHY/MAC/air interface for use by license-exempt devices on a non-interfering basis in spectrum that has already been allocated to the TV Broadcast Service. The IEEE 802.22 working group is also called the WRAN Group, since it is essentially developing an air interface for a Wireless Regional Area Network (WRAN) with a range as large as 30 miles.

An alternative idea is to standardize the use of this spectrum to provide services similar to that of the traditional IEEE 802.11 WiFi standard. This effort to use TV white space for WiFi access is known as 802.11af. The difference between the traditional 802.11 standards and 802.11 of is that 802.11 of will be for WiFi operation in the TV white spaces.

TV white space (TVWS) consists of fragments of TV channels. Thus, depending on the usage of TV broadcasting and wireless microphones, the spectrum opportunity may be 6 MHz, 12 MHz, 18 MHz, . . . assuming that a TV channel is 6 MHz wide. In addition, the spectrum opportunity may happen in any of the TV bands. Thus, the spectrum opportunity in TVWS differs from the traditional 802.11 bands of 2.4 GHz, 3.6 GHz and 5 GHz in that the center frequency and channel bandwidth are variable. A further challenge is in managing the self-coexistence of 802.11 systems as well as coexistence of 802.11 and other 802 and non-802 wireless systems within the coverage area of a device.

Another challenge is media access control of devices within a network that are within proximity of other such networks operating in TV white space. When all networks are operating with equal power levels, the hidden node problem arises. The hidden node problem is illustrated in FIG. 3. It exists, for example, when a victim network lies between two additional networks. In the example of FIG. 3, Station 1 is trying to transmit to Station 2, but Station 2 is also receiving interfering signals from Station 3 because Station 3 is not aware that Station 1 is transmitting to Station 2 as well. In effect, Station 1 is hidden from Station 3. The hidden node problem is often solved using RTS/CTS handshaking protocol. However, for devices operating in TV white space, the FCC regulations permit operation at several power levels, which gives rise to the mutated hidden node problem.

One effort to solve the mutated hidden node problem has been to relay the RTS signals in an effort to reach a higher power, interfering station. That is, RTS signals are sent from one lower power station to the next, and so forth, until one has sufficient range to reach the high power interfering station. Then, upon the high power interfering station receiving an RTS signal, it can respond back to the originating requesting station with a CTS signal.

This approach has drawbacks in that each of the low power stations must know the address of the next station to relay the RTS signals. This approach also causes a delay due to the chain of RTS signals that must occur between the originating station and the high power interfering station. This approach also requires changes to legacy 802.11 equipment and to the 802.11 frame format.

Under the present principles, methods and apparatus for media access control among a plurality of devices and networks are provided.

### SUMMARY OF THE INVENTION

The requirements that are necessary for wireless stations to implement WLANs in TV white space in proximity to other networks are addressed by the present principles, which are directed to methods and apparatus for media access control among 802.11 devices in TV white space. Using the principles described herein, methods and apparatus for media access control among devices within the TV white space (TVWS) are described that enable devices to operate in proximity of different networks.

According to an aspect of the present principles, there is provided a method for media access control in a TV white space device. The method comprises determining whether there are interference signals being transmitted within a transmission spectrum by a second device, sending a sharing request to a coexistence manager via a backhaul connection, wherein the coexistence manager is adapted to communicate the sharing request to the second device and receiving, from the second device, in response to the sharing request, a sharing authorization signal, and accessing the media in response to the sharing authorization signal.

According to an aspect of the present principles, there is provided another method for media access control in a TV white space device. The method comprises receiving a sharing request from a first device via a backhaul connection, and transmitting to a second device, via a backhaul connection, the sharing request to enable the first device to access the transmission spectrum.

According to an aspect of the present principles, there is provided another method for media access control in a TV white space device comprising receiving from a first device, via a backhaul connection, a sharing request to access a transmission spectrum, relaying to a second device, the sharing request to enable the first device to access the transmission spectrum, sending a sharing authorization signal from said second device to said first device, and transmitting information, in response to said sharing authorization signal, over the transmission spectrum.

According to an aspect of the present principles, there is provided another method for controlling media access in a WEAN comprising receiving a sharing request, via a backhaul connection, indicating that a requesting device wants to access a transmission spectrum and sending a sharing authorization signal to the requesting device.

According to another aspect of the present principles, there is provided an apparatus for media access control in a TV white space device. The apparatus is comprised of a means for transmitting and receiving signals within a transmission medium, a means for determining whether there are interference signals being transmitted within the transmission spectrum by a second device, means for communicating with a coexistence manager, adapted to communicate the sharing request to the second device, means for transmitting a sharing request to the coexistence manager, where the transmitting means is enabled to transmit and receive signals within the transmission spectrum in response to a sharing authorization signal received from the second device.

According to another aspect of the present principles, there is provided another apparatus for media access control in a TV white space device wherein a first station processes interference signals from the second station to obtain identification information to send to the coexistence manager.

According to another aspect of the present principles, there is provided an apparatus for media access control in a TV white space device. The apparatus is comprised of a receiver that receives, from a first device, via a backhaul connection, a sharing request to access a transmission spectrum, a transmitter for transmitting to a second device, via a backhaul connection, the sharing request to enable the first device to access the transmission spectrum.

According to another aspect of the present principles, there is provided an apparatus for media access control in a TV white space device. The apparatus is comprised of a receiver that receives from a first device via a backhaul connection, a sharing request to access a transmission spectrum, a circuit that relays via a backhaul connection, the sharing request to a second device to enable the first device to access the transmission spectrum, a signaling circuit for sending a sharing authorization signal from said second device to the first device and a transmitter that transmits information in response to the sharing authorization signal over the transmission spectrum.

According to another aspect of the present principles, there is provided an apparatus for media access control in a TV white space device. The apparatus is comprised of a receiver that receives a sharing request, via a backhaul connection, indicating that a requesting device wants to access a transmission spectrum and a circuit that sends a sharing authorization signal to the requesting device.

These and other aspects, features and advantages of the present principles will become apparent from the following detailed description of exemplary embodiments, which is to be read in connection with the accompanying drawings.

### BRIEF DESCRIPTION OF THE DRAWINGS

FIG. 1 shows the IEEE 802.11 MAC architecture.

FIG. 2 shows an example of TV white space usage.

FIG. 3 shows an example of the hidden node problem.

FIG. 4 shows an example of the mutated hidden node problem.

FIG. 5 shows a block diagram of one embodiment under the present principles.

FIGS. 6a and 6b show embodiments of methods for media access control in a requesting device and in a coexistence manager, respectively, under the present principles.

FIGS. 7a and 7b show embodiments of methods for media access control in a system of WLANs and in an interfering device, respectively, under the present principles.

FIG. 8 shows one embodiment of an apparatus under the present principles.

FIG. 9 shows another embodiment of an apparatus under the present principles.

### DETAILED DESCRIPTION

Recently, based on the approval of FCC, unlicensed radio transmitters can utilize the broadcast television spectrum at locations where that spectrum is not being used by licensed services, according to IEEE Standard for Information Technology-Telecommunications and Information Exchange Between Systems-Local and Metropolitan Area Networks-Specific Requirements—Part 11: Wireless LAN Medium Access Control (MAC) and Physical Layer (PHY) Specifications,” IEEE, New York, N.Y., Jun. 2007. This unused TV spectrum is often termed “TV white space”. Several IEEE standard groups have been thinking how to use this non-licensed spectrum. Among these groups, IEEE 802.11 of group is significant because there are already tremendous 802.11 devices in the market. The 802.11 of group is standardizing use of TV white spaces for services traditionally provided by the 802.11 WLAN standard. Under the principles described herein, we describe operation of devices in different networks so that 802.11 of devices can exist with802.11af and non-802.11 of devices in this spectrum space without interference from other networks in the region. Examples of devices that may operate in TV white space are portable radios, or WLAN devices. Under these principles, WLAN devices can operate in the TV white space bands and coexist with other networks and devices. Typical WLAN devices operate within a localized wireless network area, but are capable of communication over a wide area network. WLAN devices must have the ability to detect other networks within their operating range, and then, to request and receive access to the available spectrum.

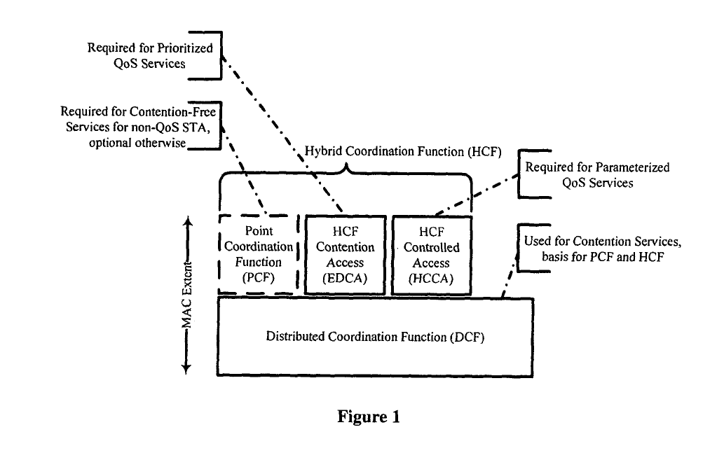

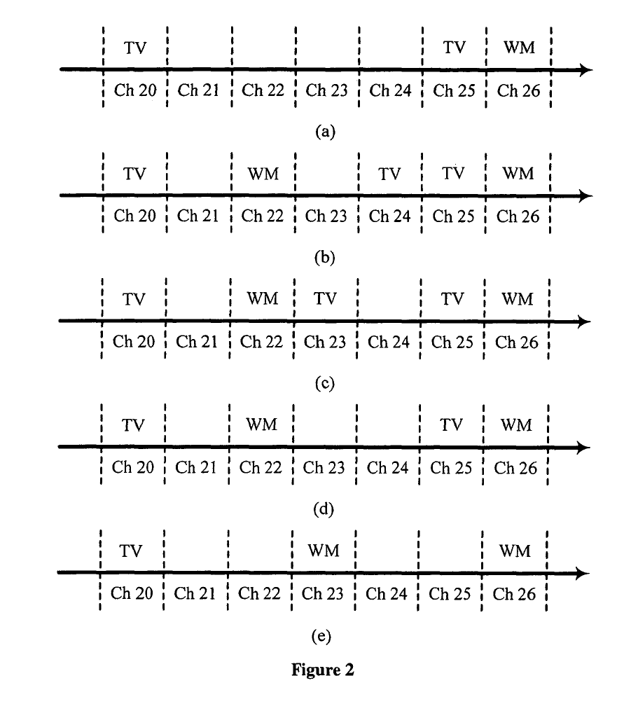

The fundamental access method of the IEEE 802.11 Medium Access Control (MAC) layer is a Distributed Coordination Function (DCF) known as Carrier Sense Multiple Access with Collision Avoidance (CSMA/CA). It is a distributed system while most of other systems such as IEEE 802.16 and IEEE 802.22 are centralized systems. As a result, it is difficult to design “a common MAC (coexistence scheme)” for 802.11 and other 802 wireless systems. FIG. 1 (from IEEE Standard for Information Technology-Telecommunications and Information Exchange Between Systems-Local and Metropolitan Area Networks-Specific Requirements—Part 11: Wireless LAN Medium Access Control (MAC) and Physical Layer (PHY) Specifications,” IEEE, New York, N.Y., June 2007) illustrates the IEEE 802.11 MAC architecture. FIG. 2 shows a number of TV channels, some occupied with TV signals and others indicating use by wireless microphones. The coexistence of heterogeneous systems can be achieved by a centralized control machine or through distributed resource contention method. Both have advantages and disadvantages. For a centralized coexistence mechanism, synchronizations of various IEEE and non-IEEE wireless systems over a wide area is a crucial control problem. The principles described herein facilitate the operation of nearby interfering networks to address a problem known as the mutated hidden node problem.

One of the issues in a point to multi-point network with at least three stations operating at equal transmission power levels is the hidden node problem. One example of the hidden node problem is illustrated in FIG. 3. In systems such as FIG. 3 that use CSMA/CA alone, a protocol is followed in which a station that wants to transmit data monitors a channel to determine if the channel is idle. If the channel is idle, the station can send a packet of information. However, if the channel is busy, the station must wait until the channel is available and its slotted time has elapsed to send its packet. Otherwise, it continues to monitor the channel until the channel is idle and its slotted time is complete.

In the example of FIG. 3, Station 2 can hear transmissions occurring from Stations 1 and 3, and Stations 1 and 3 can hear transmissions from Station 2. However, Station 1 cannot hear transmissions from Station 3 and Station 3 cannot hear transmissions from Station 1, so they are hidden from each other. Station 1 and Station 3 may both transmit at the same time, thinking that they have an idle channel because they cannot hear transmissions from the other. In that case, Station 2 would receive interfering data.

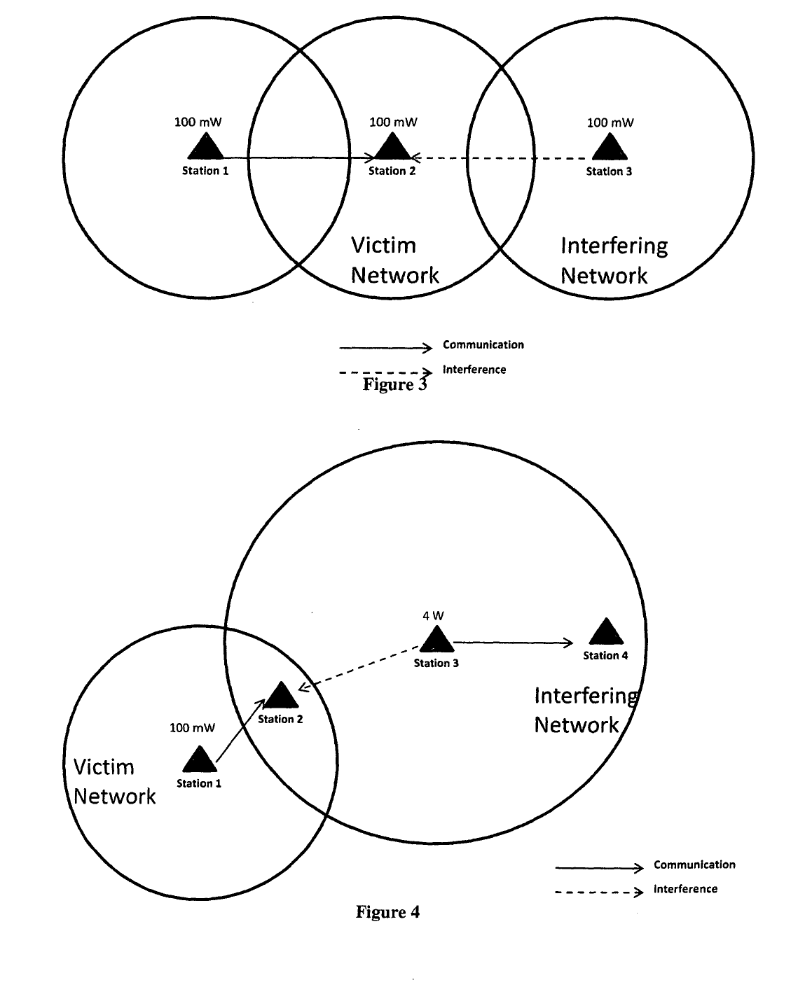

Typically, handshaking packets that use Request to Send (RTS) and Clear to Send (CTS) signals would solve the hidden node problem and so are used in addition to CSMA/CA. Additionally, information on the frame length of packets of other stations is used to perform virtual carrier sensing of the other stations. However, a further problem arises when stations within the network may operate at one of several different power levels. The Federal Communications Commission (FCC) regulation regarding TV white space (TVWS) transmission power levels allows stations to transmit at 4 W, 100 mW or 50 mW levels. This gives rise to the mutated hidden node problem. An example of the mutated hidden node problem is illustrated in FIG. 4.

In FIG. 4, a low power victim network operates at a level of 100 mW. It is comprised of a Station 1 and Station 2. A nearby, overlapping high power interfering network operates at a level of 4 W. It is comprised of a Station 3 and Station 4. In one case, Station 2 may be receiving transmissions from both Station 1 and Station 3 at the same time, which would corrupt its intended received data from Station 1. In another scenario, Station 1 could send a RTS signal to Station 2. Station 2 responds with a CTS signal to Station 1, to initiate its transmission. However, because Station 2 is part of a low power network, the CTS signal from Station 2 is never heard by Station 3, so Station 3 may never know that Station 2 is being talked to by the hidden Station 1. If Station 3 begins to transmit also, the data from Station 1 to Station 2 will be corrupted by unintended transmissions from Station 3.

It is shown herein in accordance with the embodiments of the present principles that the mutated hidden node problem can be solved when a backhaul connection is available. A backhaul connection is an alternate link, or connection, that a network has to other networks or destinations. In the context considered here, a backhaul connection may be available for low power and high power stations, for example, to the Internet. This would allow any of the stations to communicate with a device that may reside at another location accessible to the Internet, for example.

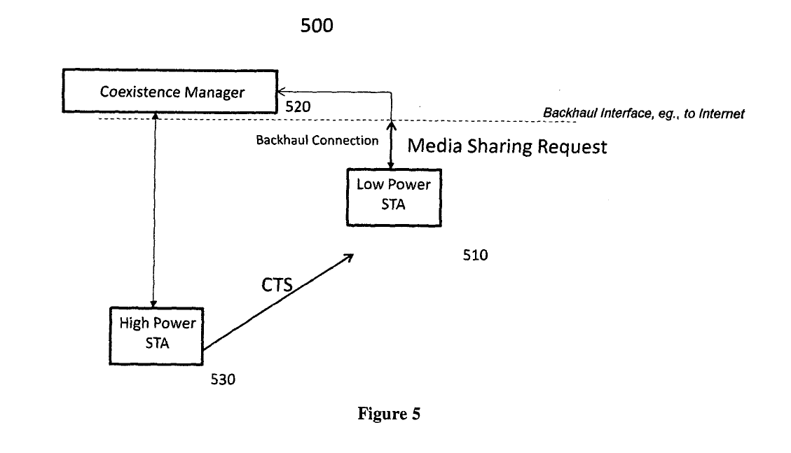

One embodiment under the present principles in solving the mutated hidden node problem is illustrated in FIG. 5. FIG. 5 shows a low power station 510 and a high power station 520. The low power station has access via a backhaul connection to a coexistence manager 530. The coexistence manager is not necessarily part of the wireless network, but can send and receive data to the stations via a backhaul connection. The coexistence manager processes requests for access to the transmission medium and can communicate to any device that has access to the medium, for example, over a backhaul connection. A backhaul connection is any communication link between the devices and the coexistence manager, other than links over the wireless medium that the various devices are trying to gain access. The coexistence manager may reside anywhere, for example, at a particular address on the internet. The low power station and the high power station may also reside at different locations.

The mutated hidden known problem was described as existing when, for example, a high power station cannot hear low power stations, such as when a low power station sends a clear-to-send (CTS) signal. If the low power station has internet access through the backhaul link of FIG. 5, the mutated hidden node problem can be addressed in several ways.

First, the low power station may know that a high power station is causing it interference. In this case, the low power station can send a medium sharing request to the interfering high power station through the coexistence manager using the backhaul link. The coexistence manager can, for example, then contact the high power station by sending the medium sharing request and the high power station can share its access right with the requesting low power station, for example, by sending a sharing authorization signal, which, for example, could be similar to a clear-to-send (CTS) signal, to the low power station. If however, the low power station is not sure which high power station is causing its interference, it can decode interference signals from the high power stations and obtain information, if available, such as the MAC/IP address of the interfering high power station. It then proceeds to operate as in the case just mentioned, knowing which station caused the interference and sending a sharing request to the coexistence manager through the backhaul link and receiving a signal from the second, high power station indicating access to the spectrum.

A second way to address the mutated hidden node problem occurs if the low power station cannot identify the signals that are causing its interference. In this case, the low power station cannot obtain information from the interfering signal, so there is a need to further identify the station generating the interference from interactions between possible stations. The coexistence manager can arrange the transmissions of specific high power stations that may be causing the interference to see if the interference is coming from those specific stations. In this regard, arranging the transmissions can be, but not limited to, simple scheduling of test transmission signals from each of the plurality of high power stations, for example. After the interference at the low power station has been observed, the coexistence manager determines which high power station was transmitting at the time. Then the low power station can send its medium sharing request to that high power station through the coexistence manager. The high power station will receive the medium sharing request through the coexistence manager, and can then share its medium access right with the requesting low power station through, for example, the coexistence manager.

A coexistence manager may, for example, also perform tasks such as scheduling the timeslots in which transmission of the high power stations, or transmission of the requesting low power stations, may occur. The coexistence manager may also schedule test transmissions of each of the high power stations and, upon receiving an indication from a requesting station that the station has detected interference, be able to determine from which of the plurality of high power stations the interference was received. The coexistence manager could then inform that particular interfering station to signal to the requesting station when the requesting station has access to the transmission spectrum.

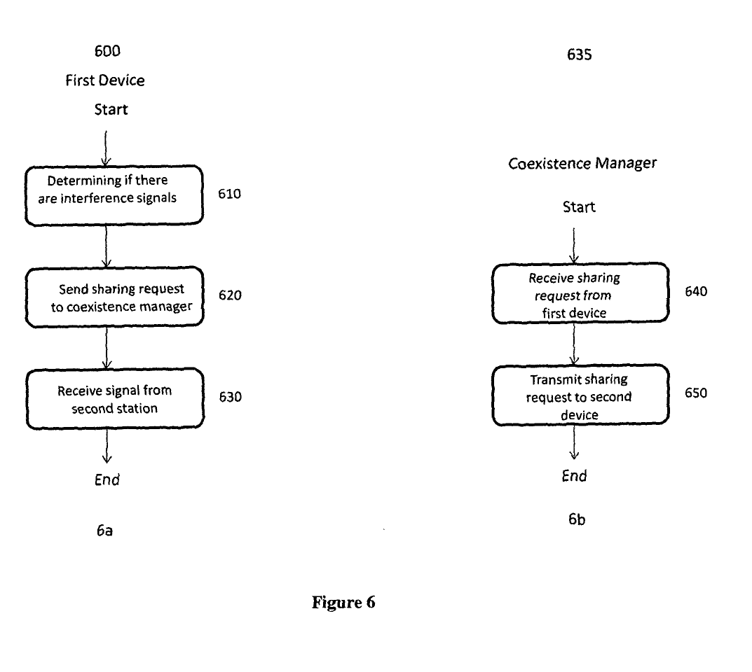

One embodiment of the present principles is shown in FIG. 6a which shows a method 600 for medium access control in a TV white space device. The method comprises a step 610 of determining if there are interference signals in a first device. The method also comprises sending a sharing request to a coexistence manager, 620, and receiving a signal from a second station enabling access to a transmission spectrum. Another embodiment is shown in FIG. 6b which shows a method 635 for medium access control in a coexistence manager. The method comprises receiving a sharing request from a first device, via a backhaul connection, in step 640 and transmitting the sharing request to a second device, via a backhaul connection, to enable the first device to access a transmission spectrum in step 650.

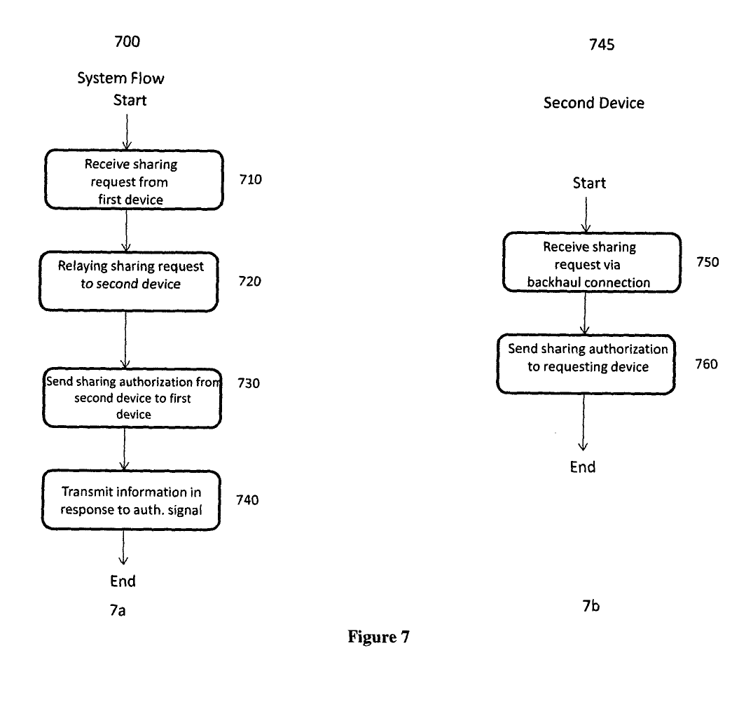

Another embodiment of the present principles is illustrated by FIG. 7a, which shows a method 700 for media access control in a TV white space system. The method comprises the step 710 of receiving a sharing request from a first station transmitting at a first power level to a coexistence manager by way of a backhaul connection. The method also comprises the step 720 of the coexistence manager relaying the sharing request to a second device, or plurality of second devices. In step 730, a sharing authorization is sent from the second device, or one of the plurality of second devices, to the first device. In step 740, the first station receives the sharing authorization signal from one of the second stations transmitting at a second power level to indicate that the first station can use a portion of spectrum and the first station transmits information over the transmission spectrum.

In FIG. 7b, a method 735 for media access control in a second TV white space device is shown. Typically, the second TV white space device is a higher power station than the first station. The method comprises receiving a sharing request for a first device via a backhaul connection, in step 750. The method further comprises sending a sharing authorization signal to the requesting device, in step 760.

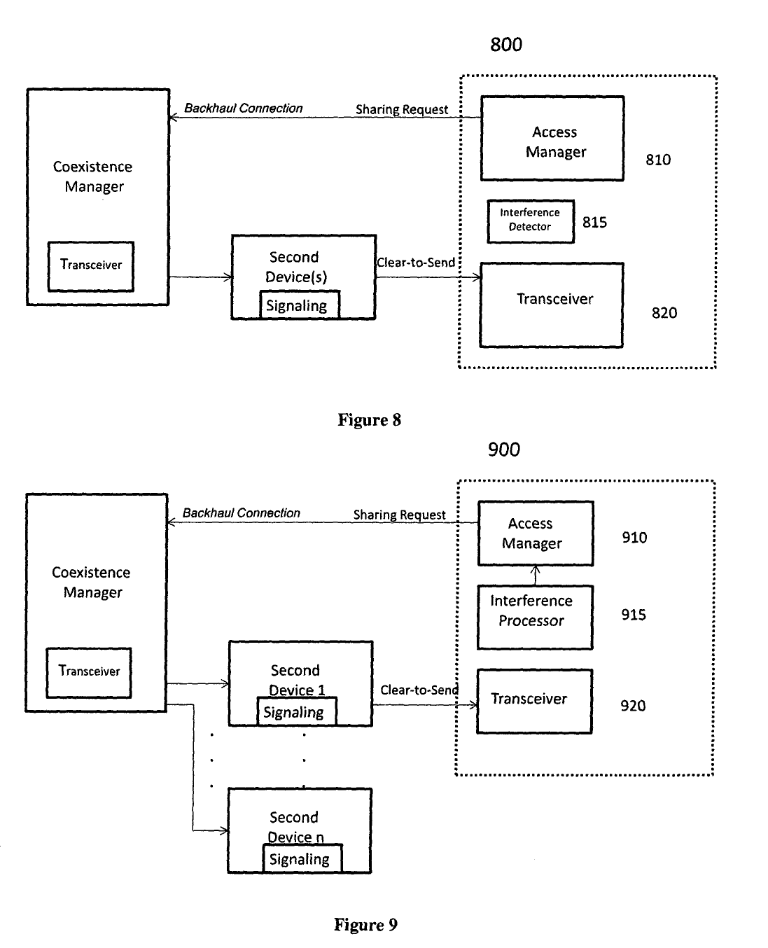

Another embodiment of the present principles is illustrated by FIG. 8, which shows an apparatus 800 for media access control in a TV white space device. The apparatus comprises an access manager, 810, that has an interface to a backhaul connection. The access manager sends a sharing request from a first station, transmitting at a first power level, to a coexistence manager by way of a backhaul connection. The coexistence manager communicates with a second station to indicate that the first station is requesting access to spectrum. The apparatus is also comprised of a receiver 820 that receives a signal from the second station, transmitting at a second higher power level than the first station, indicating to the first station that it can use a portion of the spectrum.

Another embodiment of the present principles is illustrated by FIG. 9, which shows an apparatus for media access control in a TV white space device. The apparatus comprises an access manager 910 that has an interface to a backhaul connection. The access manager sends a sharing request from a first station to a coexistence manager by way of a backhaul connection. The coexistence manager arranges the transmissions of a plurality of second stations to determine interference levels to the first station. The apparatus also comprises an interference processor 915 that is in signal communication with access manager, 910. The interference processor processes interference signals that it receives from the plurality of second stations and sends information to the access manager about the interference. The access manager sends a second sharing request from the first station to the coexistence manager by way of the backhaul connection to indicate interference from one of the second stations. The apparatus is further comprised of a receiver 920 that receives a signal from one of the second stations indicating to the first station that it can use a portion of spectrum to transmit data. The power level of the first station is less than the power levels of the second stations.

Reference in the specification to “one embodiment” or “an embodiment” or “one implementation” or “an implementation” of the present principles, as well as other variations thereof, mean that a particular feature, structure, characteristic, and so forth described in connection with the embodiment is included in at least one embodiment of the present principles. Thus, the appearances of the phrase “in one embodiment” or “in an embodiment” or “in one implementation” or “in an implementation”, as well any other variations, appearing in various places throughout the specification are not necessarily all referring to the same embodiment.

The implementations described herein may be implemented in, for example, a method or a process, an apparatus, a software program, a data stream, or a signal. Even if only discussed in the context of a single form of implementation (for example, discussed only as a method), the implementation of features discussed may also be implemented in other forms (for example, an apparatus or program). An apparatus may be implemented in, for example, appropriate hardware, software, and firmware. The methods may be implemented in, for example, an apparatus such as, for example, a processor, which refers to processing devices in general, including, for example, a computer, a microprocessor, an integrated circuit, or a programmable logic device. Processors also include communication devices, such as, for example, computers, cell phones, portable/personal digital assistants (“PDAs”), and other devices that facilitate communication of information between end-users.

Implementations of the various processes and features described herein may be embodied in a variety of different equipment or applications, particularly, for example, equipment or applications associated with data encoding and decoding. Examples of such equipment include an encoder, a decoder, a post-processor processing output from a decoder, a pre-processor providing input to an encoder, a video coder, a video decoder, a video codec, a web server, a set-top box, a laptop, a personal computer, a cell phone, a PDA, and other communication devices. As should be clear, the equipment may be mobile and even installed in a mobile vehicle. Additionally, the methods may be implemented by instructions being performed by a processor, and such instructions (and/or data values produced by an implementation) may be stored on a processor-readable medium such as, for example, an integrated circuit, a software carrier or other storage device such as, for example, a hard disk, a compact diskette, a random access memory (“RAM”), or a read-only memory (“ROM”). The instructions may form an application program tangibly embodied on a processor-readable medium. Instructions may be, for example, in hardware, firmware, software, or a combination. Instructions may be found in, for example, an operating system, a separate application, or a combination of the two. A processor may be characterized, therefore, as, for example, both a device configured to carry out a process and a device that includes a processor-readable medium (such as a storage device) having instructions for carrying out a process. Further, a processor-readable medium may store, in addition to or in lieu of instructions, data values produced by an implementation.

As will be evident to one of skill in the art, implementations may produce a variety of signals formatted to carry information that may be, for example, stored or transmitted.

The information may include, for example, instructions for performing a method, or data produced by one of the described implementations. Such a signal may be formatted, for example, as an electromagnetic wave (for example, using a radio frequency portion of spectrum) or as a baseband signal. The formatting may include, for example, encoding a data stream and modulating a carrier with the encoded data stream. The information that the signal carries may be, for example, analog or digital information. The signal may be transmitted over a variety of different wired or wireless links, as is known. The signal may be stored on a processor-readable medium.

A description will now be given of the many attendant advantages and features of the present principles, some of which have been mentioned above. For example, one advantage using the present principles for media access control is a method for addressing the mutated hidden node problem for overlapping networks operating in TV white space. The method comprises determining whether there are interference signals being transmitted within a transmission spectrum by a second device, sending a sharing request to a coexistence manager via a backhaul connection, wherein the coexistence manager is adapted to communicate the sharing request to the second device and receiving, from the second device, in response to the sharing request, a sharing authorization signal, and accessing the media in response to the sharing authorization signal. The first device operates at a lower power level than the second device. This method enables smaller powered stations to operate in proximity of networks operating at higher power levels.

Another advantage of the previous method is an embodiment in which the first station processes interference signals from the second station to obtain identification information to send to the coexistence manager. This method enables the coefficient manager to contact the second station to alert it that the first station wishes to transmit.

Yet another advantage of the present principles is a method for media access control in a TV white space device that comprises sending a request from a first station to a coexistence manager by way of a backhaul connection to share a portion of spectrum. The coexistence manager coordinates transmissions from a plurality of second networks so that the first station can detect interference. The method further comprises processing the interference from one or more of the plurality of second stations and sending a signal to the coexistence manager indicating that interference was detected. The method further comprises receiving a signal from one of the plurality of second stations indicating to the first station that it can use a portion of spectrum, wherein the second station communicates with the coexistence manager and wherein the second station operates at a power level higher than the power level of the first station. This method enables smaller powered stations to operate in proximity of networks operating at higher power levels when the first station is not certain of the identification of the interfering network.

Another advantage of a method under the present principles is a method for controlling media access in a WLAN comprising receiving a sharing request from a first device via a backhaul connection, and transmitting to a second device, via a backhaul connection, the sharing request to enable the first device to access the transmission spectrum.

Yet another advantage of a method under the present principles is a method for controlling media access in a WLAN comprising receiving from a first device, via a backhaul connection, a sharing request to access a transmission spectrum, relaying to a second device, the sharing request to enable the first device to access the transmission spectrum, sending a sharing authorization signal from said second device to said first device, and transmitting information, in response to said sharing authorization signal, over the transmission spectrum.

Yet another advantage of a method under the present principles is a method for controlling media access in a WLAN comprising receiving a sharing request, via a backhaul connection, indicating that a requesting device wants to access a transmission spectrum and sending a sharing authorization signal to the requesting device.

A further advantage of the present principles is an apparatus for media access control in a TV white space device. The apparatus is comprised of a means for transmitting and receiving signals within a transmission medium, a means for determining whether there are interference signals being transmitted within the transmission spectrum by a second device, means for communicating with a coexistence manager, adapted to communicate the sharing request to the second device, means for transmitting a sharing request to the coexistence manager, where the transmitting means is enabled to transmit and receive signals within the transmission spectrum in response to a sharing authorization signal received from the second device.

Yet another advantage of the present principles is the apparatus for media access control in a TV white space device previously mentioned, wherein a first station processes interference signals from the second station to obtain identification information to send to the coexistence manager.

A further advantage of the present principles is an apparatus for media access control in a TV white space device. The apparatus is comprised of a receiver that receives, from a first device, via a backhaul connection, a sharing request to access a transmission spectrum, a transmitter for transmitting to a second device, via a backhaul connection, the sharing request to enable the first device to access the transmission spectrum.

A further advantage of the present principles is an apparatus for media access control in a TV white space device. The apparatus is comprised of a receiver that receives from a first device via a backhaul connection, a sharing request to access a transmission spectrum, a circuit that relays via a backhaul connection, the sharing request to a second device to enable the first device to access the transmission spectrum, a signaling circuit for sending a sharing authorization signal from said second device to the first device and a transmitter that transmits information in response to the sharing authorization signal over the transmission spectrum.

A further advantage of the present principles is an apparatus for media access control in a TV white space device. The apparatus is comprised of a receiver that receives a sharing request, via a backhaul connection, indicating that a requesting device wants to access a transmission spectrum and a circuit that sends a sharing authorization signal to the requesting device.

A number of implementations have been described. Nevertheless, it will be understood that various modifications may be made. For example, elements of different implementations may be combined, supplemented, modified, or removed to produce other implementations. Additionally, one of ordinary skill will understand that other structures and processes may be substituted for those disclosed and the resulting implementations will perform at least substantially the same function(s), in at least substantially the same way(s), to achieve at least substantially the same result(s) as the implementations disclosed. Accordingly, these and other implementations are contemplated by this disclosure and are within the scope of this disclosure.

1. A method for media access control by a first device, comprising:
determining whether there are interference signals being transmitted within a transmission spectrum by a second device, which is transmitting at a higher power level than the first device;
sending a sharing request to a coexistence manager by way of a backhaul connection, wherein the coexistence manager is adapted to communicate the sharing request to the second device;
receiving, from the second device, in response to the sharing request, a sharing authorization signal, and accessing media in response to the sharing authorization signal.

2. The method of claim 1, further comprising:
processing interference signals from the second station in said first station to obtain identification information to send to the coexistence manager.

3. The method of claim 1, wherein the media is transmission spectrum in TV white space.

4. The method of claim 1, wherein the devices are connected to a WLAN associated with IEEE 802.11 standards.

5. The method of claim 1, wherein communication to the second device is through a backhaul connection.

6. The method of claim 1, wherein the second device comprises a plurality of second devices, and the first device determines which second device is the interfering second device.

7. The method of claim 1, wherein the sharing authorization signal is valid for transmission in at least one specified time slot.

8. The method of claim 1, wherein the coexistence manager is coupled to the first and second devices through the Internet.

9. The method of claim 1, wherein said determining step comprises:
sending a request to said coexistence manager through a backhaul connection to schedule transmissions among a plurality of second devices;
detecting that interference from at least one of the plurality of second devices is present.

10. An apparatus, comprising;
means for transmitting and receiving signals within a transmission spectrum;
means for determining whether there are interference signals being transmitted within the transmission spectrum by a second device;
means for communicating with a coexistence manager, wherein the coexistence manager is adapted to communicate the sharing request to the second device;
means, in response to the means for determining, for transmitting a sharing request to the coexistence manager;
wherein said transmitting means is enabled to transmit and receive signals within the transmission spectrum in response to a sharing authorization signal received from the second device.

11. (canceled)

12. (canceled)

13. (canceled)

14. (canceled)

15. (canceled)

16. (canceled)

17. (canceled)

18. (canceled)

19. A method for controlling media access control in a WLAN, comprising:
receiving, from a first device, via a backhaul connection, a sharing request to access a transmission spectrum;
transmitting, to a second device, via a backhaul connection, the sharing request to enable the first device to access the transmission spectrum.

20. The method of claim 19, further comprising:
receiving information from the first device, said information being derived from interference signals of said second device to said first device, conveying identification information of said second device.

21. The method of claim 19, wherein the media is transmission spectrum in TV white space.

22. The method of claim 19, wherein the devices are connected to a WLAN associated with IEEE 802.11 standards.

23. The method of claim 19, wherein the second device comprises a plurality of second devices, and the first device determines which second device is the interfering second device.

24. The method of claim 19, wherein the backhaul connection to the first and second devices is through the Internet.

25. The method of claim 19, wherein said transmitting step comprises:
scheduling, through a backhaul connection, transmissions among a plurality of second devices;
sending a signal to one of the plurality of second devices to enable the first device to access the transmission spectrum.

26. An apparatus for controlling media access control in a WLAN, comprising:
a receiver that receives, from a first device, via a backhaul connection, a sharing request to access a transmission spectrum;
a transmitter for transmitting to a second device, via a backhaul connection, the sharing request to enable the first device to access the transmission spectrum.

27. (canceled)

28. (canceled)

29. (canceled)

30. (canceled)

31. (canceled)

32. (canceled)

33. A method for controlling media access control in a WLAN, comprising:
receiving, from a first device, via a backhaul connection, a sharing request to access a transmission spectrum;
relaying, to a second device, via a backhaul connection, the sharing request to enable the first device to access the transmission spectrum;
sending a sharing authorization signal from said second device to said first device; and
transmitting information, in response to said sharing authorization signal, over the transmission spectrum.

34. The method of claim 33, further comprising:
receiving information from the first device, said information being derived from interference signals of said second device to said first device, conveying identification information of said second device.

35. The method of claim 33, wherein the media is transmission spectrum in TV white space.

36. The method of claim 33, wherein the devices are connected to a WLAN associated with IEEE 802.11 standards.

37. The method of claim 33, wherein the second device comprises a plurality of second devices, and the first device determines which second device is the interfering second device.

38. The method of claim 33, wherein the backhaul connection to the first and second devices is through the internet.

39. The method of claim 33, wherein said relaying step comprises:
scheduling, through a backhaul connection, transmissions among a plurality of second devices.

40. An apparatus for controlling media access control in a WLAN, comprising:
a receiver that receives from a first device, via a backhaul connection, a sharing request to access a transmission spectrum;
a circuit that relays, to a second device, via a backhaul connection, the sharing request to enable the first device to access the transmission spectrum;
a signaling circuit for sending a sharing authorization signal from said second device to said first device; and
a transmitter that transmits information, in response to said sharing authorization signal, over the transmission spectrum.

41. (canceled)

42. (canceled)

43. (canceled)

44. (canceled)

45. (canceled)

46. (canceled)

47. A method for controlling media access in a WLAN by a device, comprising:
receiving a sharing request, via a backhaul connection, indicating that a requesting device wants to access a transmission spectrum; and
sending a sharing authorization signal to said requesting device.

48. The method of claim 47, wherein the media is transmission spectrum in TV white space.

49. The method of claim 47, wherein the device and said requesting device are connected to a WLAN associated with IEEE 802.11 standards.

50. The method of claim 47, wherein said device is a plurality of second devices.

51. The method of claim 47, wherein the backhaul connection is the Internet.

52. The method of claim 47, wherein the device receives an indication, via a backhaul connection, when it should transmit, to enable said requesting device to detect a transmission from said device.

53. An apparatus for controlling media access in a WLAN by a device, comprising:
a receiver that receives a sharing request, via a backhaul connection, indicating that a requesting device wants to access a transmission spectrum; and
a circuit that sends a sharing authorization signal to said requesting device.

54. (canceled)

55. (canceled)

56. (canceled)

57. (canceled)

58. (canceled)
